(19) United States
(12) Patent Application Publication
(10) Pub. No.: US 2022/0252874 A1
(43) Pub. Date: Aug. 11, 2022

(54) OPTICAL IMAGING LENS OF REDUCED SIZE, IMAGING MODULE, AND ELECTRONIC DEVICE

(71) Applicant: HON HAI PRECISION INDUSTRY CO., LTD., New Taipei (TW)

(72) Inventors: GWO-YAN HUANG, New Taipei (TW); HSING-CHEN LIU, New Taipei (TW); CHIA-CHIH YU, New Taipei (TW)

(21) Appl. No.: 17/577,737

(22) Filed: Jan. 18, 2022

(30) Foreign Application Priority Data
Feb. 9, 2021 (CN) 202110178227.5

(51) Int. Cl. G02B 27/00; G02B 9/62; G02B 13/00

(52) U.S. Cl. CPC G02B 27/0081; G02B 13/0045; G02B 9/62

(57) ABSTRACT

An optical imaging lens is composed of a first lens, a second lens having a positive refractive power, a third lens having a negative refractive power, a fourth lens, a fifth lens having a positive refractive power, and a sixth lens having a negative refractive power. At least one of the object surface of the fifth lens, the image surface of the fifth lens, the object surface of the sixth lens, and the image surface of the sixth lens is aspheric, having at least one critical point near the optical axis. The optical imaging lens meets formula 50<V6<60, 2<TTL/EPD<3, V6 being the dispersion coefficient of the sixth lens, TTL being the distance from the side of the first lens to the image surface of the optical imaging lens on the optical axis, and EPD being the entrance pupil diameter of the optical imaging lens.

### FIELD

The subject matter relates to optical technologies, and more particularly, to an optical imaging lens, an imaging module having the optical imaging lens, and an electronic device having the imaging module.

### BACKGROUND

Portable electronic devices, such as computerized vehicles, tablet computers, and mobile phones, may be equipped with optical imaging lenses. When the electronic devices become smaller, higher quality optical imaging lenses are needed.

The optical imaging lens may need a large aperture to meet requirements in night-time photography and motion capture (dynamic) photography. However, fitting such an optical imaging lens in a small electronic device is problematic. Thus, optical imaging lens having a wide field of view and a large aperture is needed.

### BRIEF DESCRIPTION OF THE DRAWINGS

Implementations of the present technology will now be described, by way of example only, with reference to the attached figures.

FIG. 1 is a diagrammatic view of a first embodiment of an optical imaging lens according to the present disclosure.

FIG. 2 is a diagram of Modulation Transfer Function (MTF) curves of the optical imaging lens of FIG. 1.

FIG. 3 is a diagram of field curvatures of the optical imaging lens of FIG. 1.

FIG. 4 is a diagram of distortions of the optical imaging lens of FIG. 1.

FIG. 5 is a diagrammatic view of a second embodiment of an optical imaging lens according to the present disclosure.

FIG. 6 is a diagram of MTF curves of the optical imaging lens of FIG. 5.

FIG. 7 is a diagram of field curvatures of the optical imaging lens of FIG. 5.

FIG. 8 is a diagram of distortions of the optical imaging lens of FIG. 5.

FIG. 9 is a diagrammatic view of a third embodiment of an optical imaging lens according to the present disclosure.

FIG. 10 is a diagram of MTF curves of the optical imaging lens of FIG. 9.

FIG. 11 is a diagram of field curvatures of the optical imaging lens of FIG. 9.

FIG. 12 is a diagram of distortions of the optical imaging lens of FIG. 9.

FIG. 13 is a diagrammatic view of a fourth embodiment of an optical imaging lens according to the present disclosure.

FIG. 14 is a diagram of MTF curves of the optical imaging lens of FIG. 13.

FIG. 15 is a diagram of field curvatures of the optical imaging lens of FIG. 13.

FIG. 16 is a diagram of distortions of the optical imaging lens of FIG. 13.

FIG. 17 is a diagrammatic view of an embodiment of an imaging module according to the present disclosure.

FIG. 18 is a diagrammatic view of an embodiment of an electronic device using the optical imaging lens according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

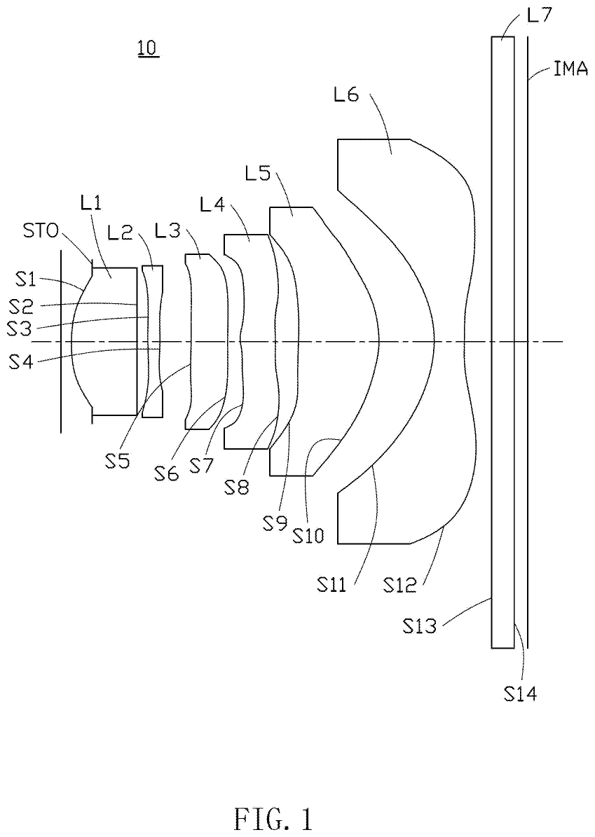

Referring to FIG. 1, an embodiment of an optical imaging lens 10 is provided. The optical imaging lens 10 includes, from object side to image side, a first lens L1, a second lens L2 with a positive refractive power, a third lens L3 with a negative refractive power, a fourth lens L4, a fifth lens L5 with a positive refractive power, and a sixth lens L6 with a negative refractive power. The refractive powers of the first lens L1 and the fourth lens L4 are not limited in the present disclosure.

The first lens L1 has an object surface (facing out towards the object) S1 and an image surface (facing in to the imaging side) S2. The second lens L2 has an object surface S3 and an image surface S4. The third lens L3 has an object surface 55 and an image surface S6. The fourth lens L4 has an object surface S7 and an image surface S8. The fifth lens L5 has an object surface 59 and an image surface S10. The object surface S9 is convex near the optical axis. The sixth lens L6 has an object surface S11 and an image surface S12. At least one of the object surface S9, the image surface S10, the object surface S11, and the image surface S12 of the sixth lens L6 is aspheric, and have or has at least one critical point near the optical axis.

Through the arrangement of different lenses in a compact space and the arrangement of the refractive power of each lens, the optical imaging lens 10 has a small size, which can be applied in an electronic device of a small size.

In some embodiments, the optical imaging lens 10 satisfies following formula (1):

50<V6<60, 2<TTL/EPD<3. (formula (1))

Wherein, V6 is a dispersion coefficient of the sixth lens L6, TTL is a distance from the object surface S1 of the first lens L1 to an image plane of the optical imaging lens 10 along the optical axis, and EPD is an entrance pupil diameter of the optical imaging lens 10. As such, the optical imaging lens 10 can have a large aperture, a wide field of view, and a small size at the same time.

In some embodiments, the object surface S1 of the first lens L1 is convex near the optical axis. The image surface S10 of the fifth lens L5 is convex near the optical axis. The object surface S11 of the sixth lens L6 is concave near the optical axis.

In some embodiments, the optical imaging lens 10 satisfies following formula (2):

0.84<Imgh/f<1.19 (formula (2)).

Wherein, Imgh is an image height corresponding to a half of a maximum field of view of the optical imaging lens 10, and f is an effective focal length of the optical imaging lens 10. As such, the optical imaging lens 10 can obtain a large viewing angle.

In some embodiments, the optical imaging lens satisfies following formula (3):

1.41<(V2+V3+V5)/(V1+V4)<1.73 (formula (3)).

Wherein, V1 is a dispersion coefficient of the first lens L1, V2 is a dispersion coefficient of the second lens L2, V3 is a dispersion coefficient of the third lens L3. V4 is a dispersion coefficient of the fourth lens L4, and V5 is a dispersion coefficient of the fifth lens L5. As such, a balance can be achieved between chromatic aberration correction and astigmatism correction, which can improve the imaging quality of the optical imaging lens 10.

In some embodiments, the optical imaging lens satisfies following formula (4):

1.07<TL1//f<1.68 (formula (4)).

Wherein, TL1 is a distance from the object surface S1 of the first lens L1 to the image plane of the optical imaging lens 10 along the optical axis, and f is the effective focal length of the optical imaging lens 10. As such, a total track length of the optical imaging lens 10 can be reduced, and the optical imaging lens 10 can have a large viewing angle.

In some embodiments, the optical imaging lens satisfies following formula (5):

35.51<FOV/TL6<124.98 (formula (5)).

Wherein, FOV is the maximum field of view of the optical imaging lens 10, and TL6 is the distance from the object surface S9 of the fifth lens L5 to the image plane of the optical imaging lens 10 along the optical axis. As such, the optical imaging lens 10 has a wide field of view.

In some embodiments, the optical imaging lens 10 satisfies following formula (6):

9.82<FOV/f<20.94 (formula (6)).

Wherein, FOV is the maximum field of view of the optical imaging lens 10, and f is the effective focal length of the optical imaging lens 10. As such, the optical imaging lens 10 has a wide field of view and a small size.

In some embodiments, the optical imaging lens 10 satisfies following formula (7):

1.41<TTL/Imgh<1.58 (formula (7)).

Wherein, TTL is the distance from the object surface S1 of the first lens L1 to the image plane of the optical imaging lens 10 along the optical axis. As such, the optical imaging lens 10 can have a small size.

In some embodiments, the optical imaging lens 10 also includes a stop STO disposed on a surface of any one of the lenses. The stop STO can also be disposed before the first lens L1. The stop STO can also be sandwiched between any two lenses. The stop STO can also be disposed on the image surface S12 of the sixth lens L6. For example, as shown in FIG. 1, the stop STO is disposed on the object surface S3 of the second lens L2. The stop STO can be a glare stop or a field stop, and can reduce stray rays and improve the image quality.

In some embodiments, the optical imaging lens 10 also includes an infrared filter L7 having an object surface S13 and an image surface S14. The infrared filter L7 is arranged on the image surface S12 of the sixth lens LG. The infrared filter L7 can filter visible rays and only allow infrared rays to pass through, so that the optical imaging lens 10 can also be used in a dark environment.

### First Embodiment

Referring to FIG. 1, the optical imaging lens 10 includes, from the object side to the image side, an aperture STO, a first lens L1 with a refractive power, a second lens L2 with a negative refractive power, a third lens L3 with a negative refractive power, a fourth lens L4 with a refractive power, a fifth lens L5 with a positive refractive power, a sixth lens 16 with a negative refractive power, and an infrared filter L7. The first lens L the second lens L2, the third lens L3, the fourth lens L4, the fifth lens L5, and the sixth lens L6 are made of glass, and the infrared filter L7 is made of glass.

The object surface S1 of the first lens L1 is convex near the optical axis, the object surface S9 of the fifth lens L5 is convex near the optical axis, the image surface S10 of the fifth lens L5 is convex near the optical axis, and the object surface S11 of the sixth lens L6 is concave near the optical axis.

When the optical imaging lens 10 is used, rays from the object side enter the optical imaging lens 10, successively pass through the stop STO, the first lens L1, the second lens L2, the third lens L3, the fourth lens L4, the fifth lens L5, the sixth lens L6, and the infrared filter L7, and finally converge on the image plane IMA.

Table 1 shows basic parameters of the optical imaging lens 10.

TABLE 1

| | |
|---|---|
| Imgh (unit: mm) | 3.4 |
| TTL (unit: mm) | 5.178247 |
| FOV (unit: °) | 39.85 |
| TL1 (unit: mm) | 4.331509 |
| TL2 (unit: mm) | 4.081124 |
| TL3 (unit: mm) | 3.330001 |
| TL4 (unit: mm) | 2.800077 |
| TL5 (unit: mm) | 1.677851 |
| TL6 (unit: mm) | 0.693684 |
| V1 | 55.9512 |
| V2 | 20.3729 |
| V3 | 55.9512 |
| V4 | 20.3729 |
| V5 | 55.9512 |
| V6 | 55.9512 |
| EPD (unit: mm) | 1.916 |
| f (unit: mm) | 4.05814 |

Wherein, TL1 is the distance between the object surface S1 of the first lens L1 and the image plane IMA of the optical imaging lens 10 along the optical axis. TL2 is the distance between the object surface S3 of the second lens L2 and the image plane IMA of the optical imaging lens 10 along the optical axis. TL3 is the distance between the object surface S5 of the third lens L3 and the image plane IMA of the optical imaging lens 10 along the optical axis. TL4 is the distance between the object surface S7 of the fourth lens L4 and the image plane IMA of the optical imaging lens 10 along the optical axis. TL5 is the distance between the object surface S9 of the fifth lens L5 and the image plane IMA of the optical imaging lens 10 along the optical axis. TL6 is the distance between the object surface S11 of the sixth lens L6 and the image plane IMA of the optical imaging lens 10 along the optical axis. For simplicity, these same definitions apply to all the following embodiments.

Table 2 shows characteristics of the optical imaging lens 10. The reference wavelength of focal length, refractive index, and Abbe number is 558 nm, and the units of radius of curvature, thickness, and semi-diameter are in millimeters (mm).

TABLE 2
First embodiment

| | | | radius of | | | refractive | Abbe | semi- |
|---|---|---|---|---|---|---|---|---|
| Surface | Lens | Type of surface | curvature | thickness | material | index | number | diameter |
| object | | standard surface | infinite | infinite | | | | infinite |
| surface | | standard surface | infinite | 0.35 | | | | 1.25 |
| STO | | standard surface | infinite | −0.24 | | | | 0.958 |
| S1 | first lens | even aspheric | 1.942 | 0.737 | glass | 1.54 | 56 | 0.964 |
| | | surface | | | | | | |
| S2 | | even aspheric | 10.273 | 0.117 | | | | 1.044 |
| | | surface | | | | | | |
| S3 | second | even aspheric | −1814.311 | 0.134 | glass | 1.66 | 20.4 | 1.056 |
| | lens | surface | | | | | | |
| S4 | | even aspheric | 15.685 | 0.34 | | | | 1.089 |
| | | surface | | | | | | |
| S5 | third lens | even aspheric | 124.704 | 0.411 | glass | 1.54 | 56 | 1.155 |
| | | surface | | | | | | |
| S6 | | even aspheric | −100.196 | 0.147 | | | | 1.245 |
| | | surface | | | | | | |
| S7 | fourth | even aspheric | 4.326 | 0.383 | glass | 1.66 | 20.4 | 1.245 |
| | lens | surface | | | | | | |
| S8 | | even aspheric | 3.878 | 0.252 | | | | 1.502 |
| | | surface | | | | | | |
| S9 | fifth lens | even aspheric | 235.134 | 0.87 | glass | 1.54 | 56 | 1.521 |
| | | surface | | | | | | |
| S10 | | even aspheric | −1.935 | 0.649 | | | | 1.911 |
| | | surface | | | | | | |
| S11 | sixth lens | even aspheric | −2.09 | 0.335 | glass | 1.52 | 56 | 2.15 |
| | | surface | | | | | | |
| S12 | | even aspheric | 3.083 | 0.334 | | | | 2.839 |
| | | surface | | | | | | |
| S13 | infrared | standard surface | infinite | 0.21 | glass | 1.52 | 64.2 | 4.3 |
| S14 | filter | standard surface | infinite | 0.15 | | | | 4.3 |
| IMA | | standard surface | infinite | 0.000 | | | | 4.3 |

Table 3 shows the aspherical coefficients of the optical imaging lens 10.

TABLE 3
First embodiment

| Surface | K | A2 | A4 | A6 | A8 | A10 | A12 | A14 |
|---|---|---|---|---|---|---|---|---|
| S1 | 0.184 | 0.000E+00 | −8.129E−003 | −2.185E−003 | −3.462E−003 | −9.263E−004 | −2.056E−004 | −3.237E−004 |
| S2 | −46.603 | 0.000E+00 | −0.028 | −0.018 | −5.949E−003 | −1.148E−003 | 4.905E−004 | 7.121E−004 |
| S3 | 8446.254 | 0.000E+00 | −0.029 | −7.108E−003 | −4.282E−003 | −8.002E−004 | 8.242E−004 | 1.226E−003 |
| S4 | 107.138 | 0.000E+00 | 1.889E−003 | −1.865E−003 | −1.850E−004 | −2.335E−003 | −9.844E−004 | −1.383E−004 |
| S5 | −7.930E+004 | 0.000E+00 | 0.013 | −0.026 | −3.228E−003 | 2.070E−003 | 1.876E−004 | −1.258E−003 |
| S6 | 4153.078 | 0.000E+00 | −0.024 | −0.023 | −6.919E−003 | −2.804E−003 | −7.059E−004 | −1.742E−004 |
| S7 | −35.738 | 0.000E+00 | −0.046 | −0.014 | −8.924E−003 | −3.154E−003 | −9.462E−004 | −6.691E−004 |
| S8 | −26.671 | 0.000E+00 | −0.042 | −9.542E−003 | −3.120E−004 | −2.645E−005 | 2.606E−005 | 7.598E−005 |
| S9 | −2.612E+004 | 0.000E+00 | −0.045 | −0.012 | −4.475E−003 | 5.427E−004 | 1.391E−003 | 4.916E−004 |
| S10 | −5.057 | 0.000E+00 | −0.014 | −3.092E−003 | 7.322E−004 | 2.759E−004 | 4.391E−005 | −3.484E−006 |
| S11 | −1.029 | 0.000E+00 | −3.272E−003 | 9.365E−004 | 1.128E−004 | −1.066E−005 | −3.995E−006 | −5.283E−007 |
| S12 | −21.117 | 0.000E+00 | −0.027 | 7.022E−003 | −1.278E−003 | 6.092E−005 | 6.180E−006 | −5.129E−007 |

It should be noted that the object surface and the image surface of each lens of the optical imaging lens 10 may be aspherical. The aspherical equation of each aspherical surface satisfies following formula (8):

$$Z = \frac{{cr}^{2}}{1 + \sqrt{1 - ( k + 1 ) {c}^{2} {r}^{2}}} + {ΣAir}^{i} . \qquad ( formula ( 8 ) )$$

Wherein, Z is the distance between any point on the aspheric surface and the vertex of the aspheric surface along the optical axis, R is the vertical distance from any point on the aspheric surface to the optical axis, C is the curvature (reciprocal of the radius of curvature) of the vertex, K is a conic constant, and Ai is a correction coefficient of i^{th} order of the aspheric surface. For simplicity, these same definitions apply to all the following embodiments. Table 3 shows the conic constant K and the high-order coefficients A2, A4, A6, A8, A10, A12 and A14 for S1 to S12 of each aspheric lens in the first embodiment.

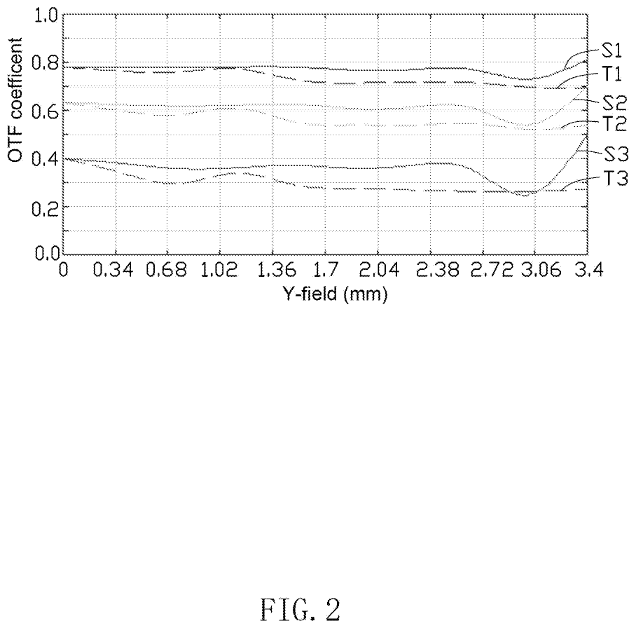

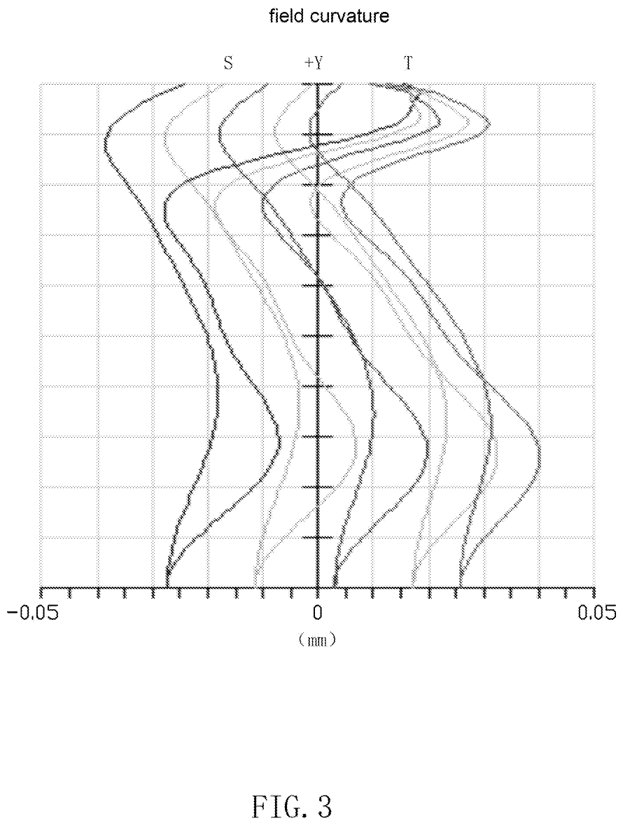

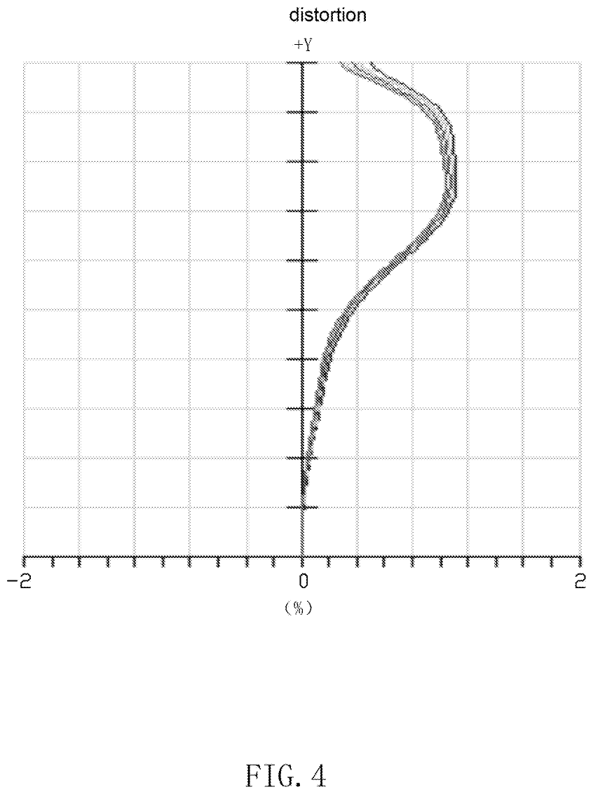

FIGS. 2 to 4 show the MTF curves, the field curvatures, and the distortions of the optical imaging lens 10 of the first embodiment, respectively. In FIG. 2, the abscissa represents Y-field offset angle, that is, an angle between the field of view of the optical imaging lens 10 and the optical axis, and the ordinate represents the OTF coefficient. The curve at a lower frequency can reflect the contrast characteristics of the optical imaging lens 10, and the curve at a higher frequency can reflect the resolution characteristics of the optical imaging lens 10. FIG. 3 represents the meridian field curvature and the sagittal field curvature, in which the maximum value of each of the sagittal field curve and the meridional field curve is less than 0.05 mm, indicating that good compensation is obtained. The distortion curve in FIG. 4 shows the distortion values corresponding to different field angles, in which the maximum distortion is less than 2%, indicating that the distortion has been corrected. Therefore, the optical imaging lens 10 can have a large aperture, a wide field of view, and a small size.

### Second Embodiment

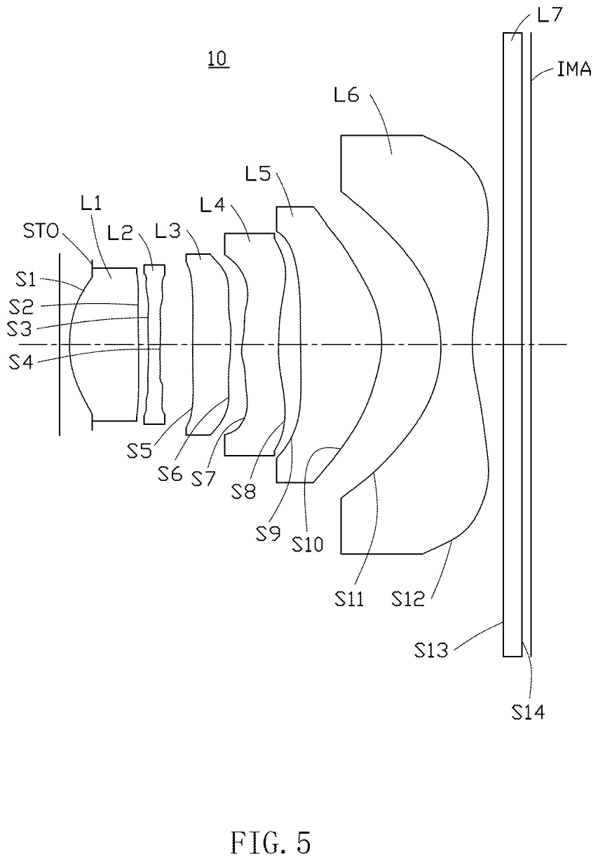

Referring to FIG. 5, the optical imaging lens 10 includes, from the object side to the image side, an aperture STO, a first lens L1 with a refractive power, a second lens L2 with a negative refractive power, a third lens L3 with a negative refractive power, a fourth lens L4 with a refractive power, a fifth lens L5 with a positive refractive power, a sixth lens 16 with a negative refractive power, and an infrared filter L7. The first lens L1, the second lens L2, the third lens L3, the fourth lens L4, the fifth lens L5 and the sixth lens L6 are made of glass, and the infrared filter L7 is also made of, glass.

The object surface S1 of the first lens L1 is convex near the optical axis, the object surface S9 of the fifth lens L5 is convex near the optical axis, the image surface S10 of the fifth lens L5 is convex near the optical axis, and the object surface S11 of the sixth lens L6 is concave near the optical axis.

When the optical imaging lens 10 is used for imaging, rays from the object side enter the optical imaging lens 10, successively pass through the stop STO, the first lens L1, the second lens L2, the third lens L3, the fourth lens L4, the fifth lens L5, the sixth lens L6 and the infrared filter L7, and finally converge on the image plane IMA.

Table 4 shows basic parameters of the optical imaging lens 10.

TABLE 4

| | |
|---|---|
| Imgh (unit: mm) | 3.4 |
| TTL (unit: mm) | 5.128247 |
| FOV (unit: °) | 40.057 |
| TL1 (unit: mm) | 4.281509 |
| TL2 (unit: mm) | 4.031124 |
| TL3 (unit: mm) | 3.280001 |
| TL4 (unit: mm) | 2.750077 |
| TL5 (unit: mm) | 1.627851 |
| TL6 (unit: mm) | 0.643684 |
| V1 | 55.9512 |
| V2 | 23.52887 |
| V3 | 55.9512 |
| V4 | 23.52887 |
| V5 | 55.9512 |
| V6 | 55.59355 |
| EPD (unit: mm) | 1.9 |
| f (unit: mm) | 3.9659 |

Table 5 shows characteristics of the optical imaging lens 10. The reference wavelength of focal length, refractive index, and Abbe number is 558 nm, and the units of radius of curvature, thickness and semi-diameter are millimeters (mm).

TABLE 5
Second embodiment

| | | | radius of | | | refractive | Abbe | semi- |
|---|---|---|---|---|---|---|---|---|
| Surface | lens | Type of surface | curvature | thickness | material | index | number | diameter |
| object | | standard surface | infinite | infinite | | | | infinite |
| surface | | standard surface | infinite | infinite | | | | 0.950 |
| STO | | standard surface | infinite | −0.24 | | | | 0.950 |
| S1 | first lens | even aspheric | 1.942 | 0.737 | glass | 1.54 | 56 | 1.034 |
| | | surface | | | | | | |
| S2 | | even aspheric | 10.273 | 0.117 | | | | 1.044 |
| | | surface | | | | | | |
| S3 | second | even aspheric | −1814.311 | 0.134 | glass | 1.64 | 23.5 | 1.047 |
| | lens | surface | | | | | | |
| S4 | | even aspheric | 15.685 | 0.34 | | | | 1.081 |
| | | surface | | | | | | |
| S5 | third lens | even aspheric | 98.503 | 0.411 | glass | 1.54 | 56 | 1.150 |
| | | surface | | | | | | |
| S6 | | even aspheric | −94.762 | 0.147 | | | | 1.240 |
| | | surface | | | | | | |
| S7 | fourth | even aspheric | 3.761 | 0.383 | glass | 1.64 | 23.5 | 1.241 |
| | lens | surface | | | | | | |
| S8 | | even aspheric | 3.184 | 0.252 | | | | 1.533 |
| | | surface | | | | | | |
| S9 | fifth lens | even aspheric | 124.849 | 0.87 | glass | 1.54 | 56 | 1.571 |
| | | surface | | | | | | |
| S10 | | even aspheric | −1.862 | 0.649 | | | | 1.895 |
| | | surface | | | | | | |
| S11 | sixth lens | even aspheric | −2.314 | 0.335 | glass | 1.53 | 55.6 | 2.111 |
| | | surface | | | | | | |
| S12 | | even aspheric | 2.628 | 0.334 | | | | 2.876 |
| | | surface | | | | | | |
| S13 | infrared | standard surface | infinite | 0.21 | glass | 1.52 | 64.2 | 4.3 |
| S14 | filter | standard surface | infinite | 0.1 | | | | 4.3 |
| IMA | | standard surface | infinite | 0.000 | | | | 4.3 |

Table 6 shows the aspherical coefficients of the optical imaging lens 10.

TABLE 6
Second embodiment

| Surface | K | A2 | A4 | A6 | A8 | A10 | A12 | A14 |
|---|---|---|---|---|---|---|---|---|
| S1 | 0.184 | 0.000E+00 | −8.129E−003 | −2.185E−003 | −3.462E−003 | −9.263E−004 | −2.056E−004 | −3.237E−004 |
| S2 | −46.663 | 0.000E+00 | −0.028 | −0.018 | −5.949E−003 | −1.148E−003 | 4.905E−004 | 7.121E−004 |
| S3 | 8446.254 | 0.000E+00 | −0.029 | −7.108E−003 | −4.282E−003 | −8.002E−004 | 8.242E−004 | 1.226E−003 |
| S4 | 107.138 | 0.000E+00 | 1.889E−003 | −1.865E−003 | −1.850E−004 | −2.335E−003 | −9.844E−004 | −1.383E−004 |
| S5 | −1.289E+004 | 0.000E+00 | 0.012 | −0.026 | −3.412E−003 | 2.008E−003 | 1.850E−004 | −1.235E−003 |
| S6 | 4621.204 | 0.000E+00 | −0.024 | −0.023 | −6.962E−003 | −2.838E−003 | −7.257E−004 | −1.855E−004 |
| S7 | −21.374 | 0.000E+00 | −0.059 | −0.018 | −6.632E−003 | −3.161E−003 | −2.136E−003 | −1.321E−004 |
| S8 | −14.864 | 0.000E+00 | −0.039 | −0.012 | −6.604E−004 | 1.203E−004 | 1.019E−004 | 6.932E−005 |
| S9 | 6223.561 | 0.000E+00 | −0.031 | −7.412E−003 | −4.220E−003 | −1.348E−004 | 1.109E−003 | 4.617E−004 |
| S10 | −4.107 | 0.000E+00 | −8.849E−003 | −4.146E−003 | 6.057E−004 | 3.517E−004 | 5.883E−005 | −5.019E−006 |
| S11 | −0.600 | 0.000E+00 | −9.357E−003 | 2.074E−003 | 1.795E−004 | −2.856E−005 | −6.508E−006 | −6.578E−007 |
| S12 | −17.147 | 0.000E+00 | −0.027 | 7.228E−003 | −1.252E−003 | 5.449E−005 | 5.707E−006 | −4.909E−007 |

It should be noted that the surface of the lens of the optical imaging lens 10 may be aspherical. For these aspherical surfaces, the aspherical equation of the aspherical surface is the above following formula (8).

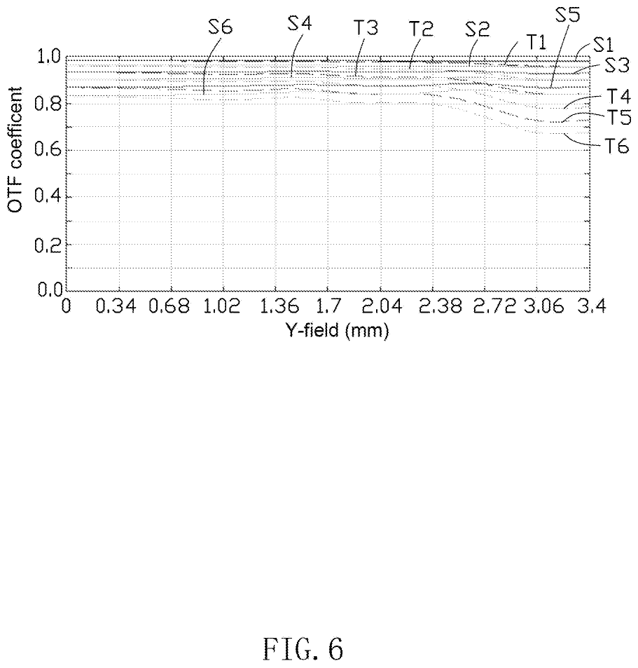

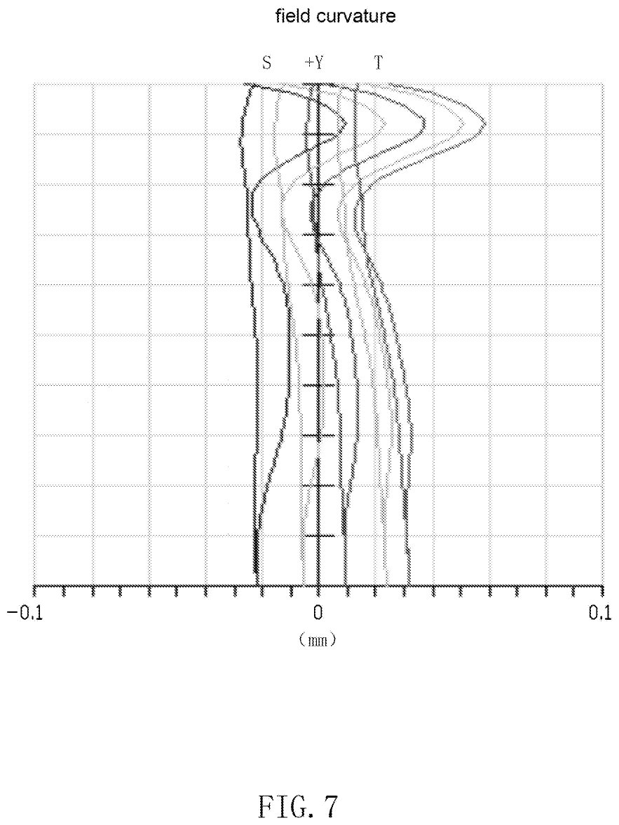

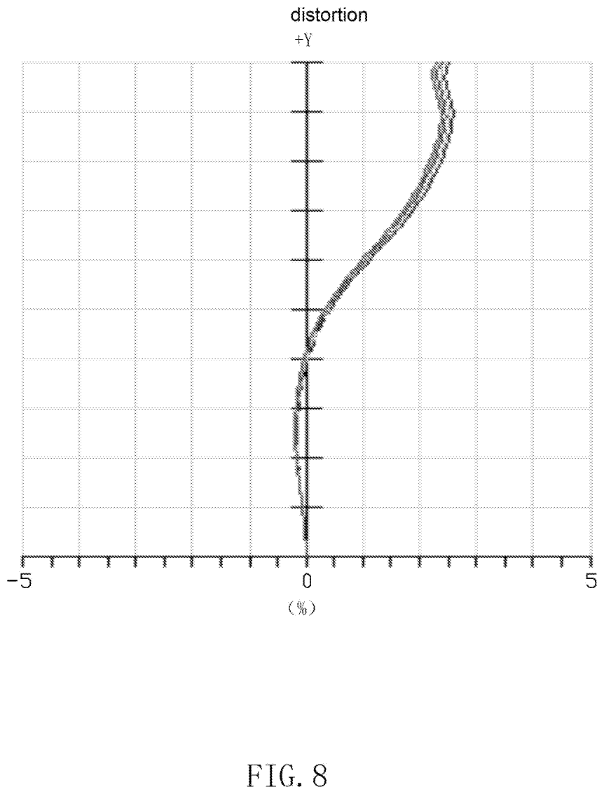

FIGS. 6 to 8 show the MTF curves, the field curvatures, and the distortions of the optical imaging lens 10 of the second embodiment, respectively. In FIG. 6, the abscissa represents the Y-field offset angle, that is, an angle between the field of view of the optical imaging lens 10 and the optical axis, and the ordinate represents the OTF coefficient. The curve at lower frequency can reflect the contrast characteristics of the optical imaging lens 10, and the curve at higher frequency can reflect the resolution characteristics of the optical imaging lens 10. FIG. 6 represents the meridian field curvature and the sagittal field curvature, in which the maximum value of each of the sagittal field curve and meridional field curve is less than 0.1 mm, indicating a good compensation is obtained. The distortion curve in FIG. 8 shows the distortion values corresponding to different field angles, in which the maximum distortion is less than 5%, indicating that the distortion has been corrected. Therefore, the optical imaging lens 10 can have a large aperture, a wide field of view, and a small size.

### Third Embodiment

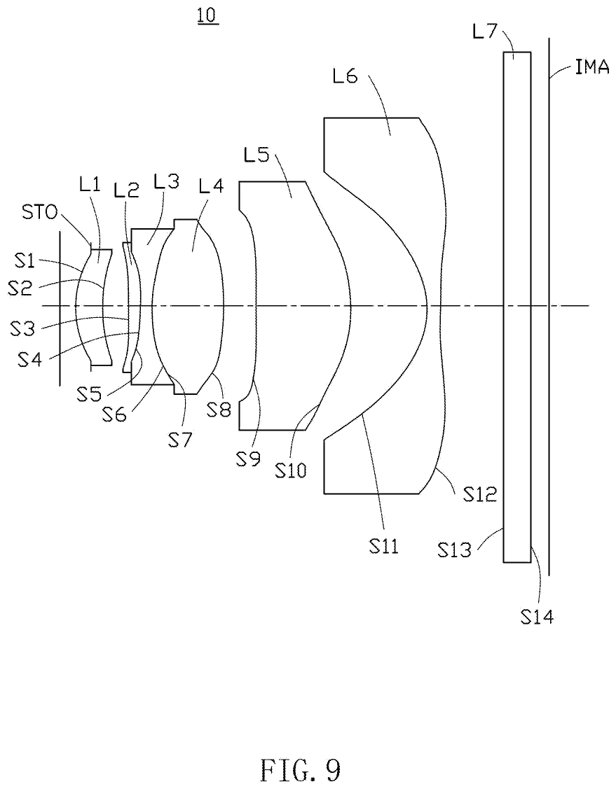

Referring to FIG. 9, the optical imaging lens 10 includes, from the object side to the image side, an aperture STO, a first lens L1 with a refractive power, a second lens L2 with a negative refractive power, a third lens L3 with a negative refractive power, a fourth lens L4 with a refractive power, a fifth lens L5 with a positive refractive power, a sixth lens 16 with a negative refractive power, and an infrared filter L7. The first lens L1, the second lens L2, the third lens L3, the fourth lens L4, the fifth lens L5, and the sixth lens L6 are made of glass, and the infrared filter L7 is also made of glass.

The object surface S1 of the first lens L1 is convex near the optical axis, the object surface S9 of the fifth lens L5 is convex near the optical axis, the image surface S10 of the fifth lens L5 is convex near the optical axis, and the object surface S11 of the sixth lens L6 is concave near the optical axis.

When the optical imaging lens 10 is used, rays from the object side enter the optical imaging lens 10, successively pass through the stop STO, the first lens L1, the second lens L2, the third lens L3, the fourth lens L4, the fifth lens L5, the sixth lens L6, and the infrared filter L7, and finally converge on the image surface IMA.

Table 7 shows basic parameters of the optical imaging lens 10.

TABLE 7

| | |
|---|---|
| Imgh (unit: mm) | 3.4 |
| TTL (unit: mm) | 4.8 |
| FOV (unit: °) | 44 |
| TL1 (unit: mm) | 4.8 |
| TL2 (unit; mm) | 4.277 |
| TL3 (unit: mm) | 4.157 |
| TL4 (unit: mm) | 4.037 |
| TL5 (unit: mm) | 2.969 |
| TL6 (unit: mm) | 1.239 |
| V1 | 58.8 |
| V2 | 54.6 |
| V3 | 32 |
| V4 | 44.5 |
| V5 | 60 |
| V6 | 52.3 |
| EPD (unit: mm) | 1.1 |
| f (unit: mm) | 2.86 |

Table 8 shows characteristics of the optical imaging lens 10. The reference wavelength of focal length, refractive index, and Abbe number is 558 nm, and the units of radius of curvature, thickness, and semi-diameter are in millimeters (mm).

TABLE 8
Third embodiment

| | | | radius of | | | refractive | Abbe | semi- |
|---|---|---|---|---|---|---|---|---|
| Surface | lens | Type of surface | curvature | thickness | material | index | number | diameter |
| object | | standard surface | infinite | infinite | | | | infinite |
| surface | | standard surface | infinite | infinite | | | | |
| STO | | standard surface | infinite | infinite | | | | |
| S1 | first lens | even aspheric | 1.729 | 0.274 | glass | 1.63 | 58.5 | 0.699 |
| | | surface | | | | | | |
| S2 | | even aspheric | 3.097 | 0.249 | | | | 0.734 |
| | | surface | | | | | | |
| S4 | second | even aspheric | 8.461 | 0.120 | glass | 1.66 | 44.4 | 0.790 |
| | lens | surface | | | | | | |
| S5 | third lens | even aspheric | 5.520 | 0.120 | glass | 1.75 | 30.3 | 0.822 |
| | | surface | | | | | | |
| S7 | fourth | even aspheric | 1.886 | 0.731 | glass | 1.62 | 45.2 | 0.991 |
| | lens | surface | | | | | | |
| S8 | | even aspheric | −5.130 | 0.336 | | | | 1.107 |
| | | surface | | | | | | |
| S9 | filth lens | even aspheric | −15.662 | 0.959 | glass | 1.62 | 59.9 | 1.258 |
| | | surface | | | | | | |
| S10 | | even aspheric | −1.919 | 0.771 | | | | 1.593 |
| | | surface | | | | | | |
| S11 | sixth lens | even aspheric | −1.328 | 0.120 | glass | 1.53 | 52.7 | 1.709 |
| | | surface | | | | | | |
| S12 | | even aspheric | 5.001 | 0.655 | | | | 2.401 |
| | | surface | | | | | | |
| S13 | infrared | standard surface | infinite | 0.264 | glass | 1.52 | 64.2 | 3.114 |
| S14 | filter | standard surface | infinite | 0.200 | | | | 3.237 |
| IMA | | standard surface | infinite | 0.000 | | | | 3.405 |

Table 9 shows the aspherical coefficients of the optical imaging lens 10.

TABLE 9
Third embodiment

| Surface | K | A2 | A4 | A6 | A8 |
|---|---|---|---|---|---|
| S1 | −1.167 | 0.000E+00 | 0.042 | −0.020 | 0.010 |
| S2 | −7.558 | 0.000E+00 | 0.028 | −7.879E−003 | −3.925E−003 |
| S4 | −2.835E+013 | 0.000E+00 | −0.062 | −0.048 | −0.070 |
| S5 | −8.863E+005 | 0.000E+00 | −0.641 | −0.828 | −0.245 |
| S7 | −16.672 | 0.000E+00 | −0.094 | −0.207 | −0.042 |
| S8 | 10.758 | 0.000E+00 | −0.084 | 2.635E−003 | −0.017 |
| S9 | −9.817E+008 | 0.000E+00 | −0.063 | 0.016 | −0.015 |
| S10 | −0.605 | 0.000E+00 | −0.033 | 0.020 | −2.686E−003 |
| S11 | −67.848 | 0.000E+00 | −0.041 | −0.015 | 4.917E−003 |
| S12 | −21.117 | 0.000E+00 | −0.017 | 1.209E−003 | −7.415E−005 |

It should be noted that the surface of the lens of the optical imaging lens 10 may be aspherical. For these aspherical surfaces, the aspherical equation of the aspherical surface is according to the above formula (8).

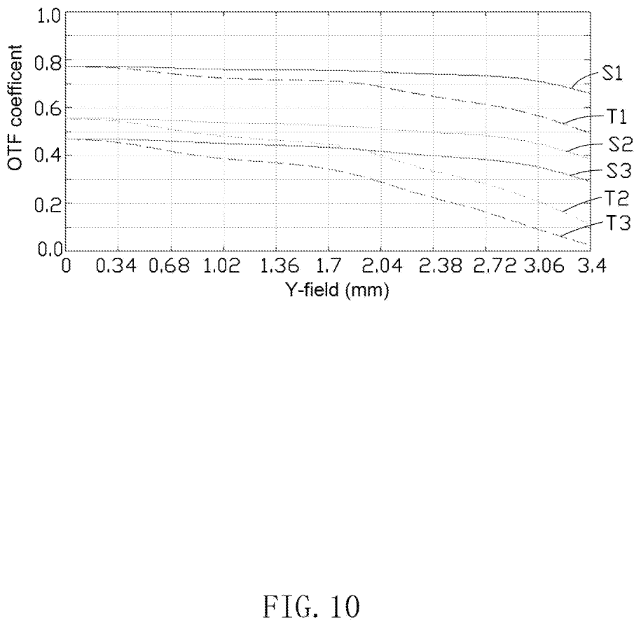

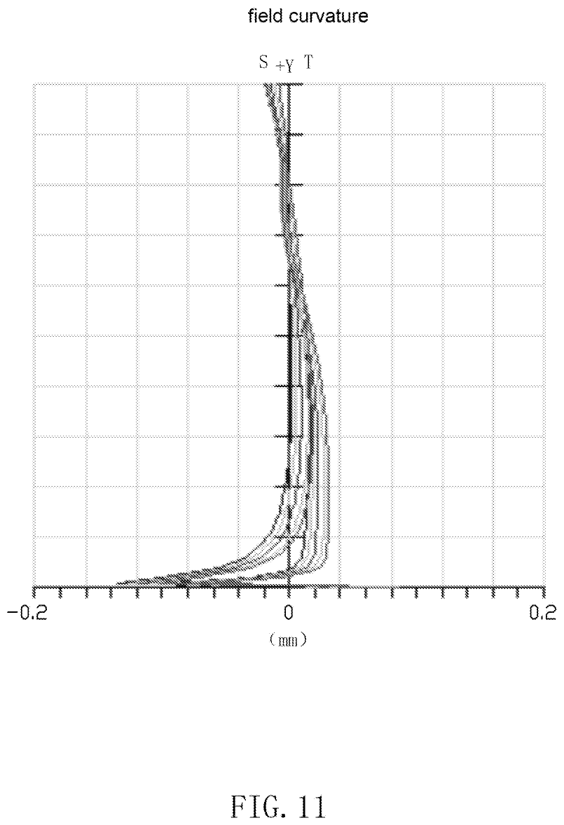

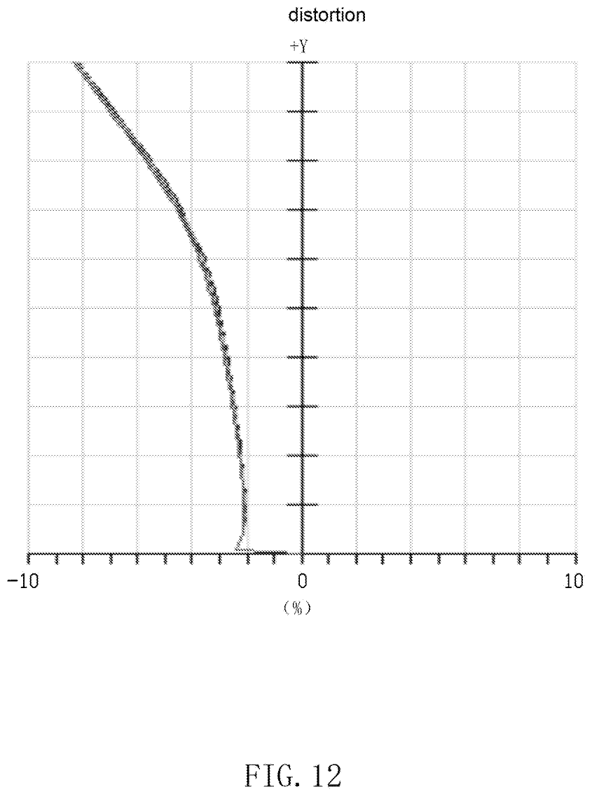

FIGS. 10 to 12 show the MTF curves, the field curvatures, and the distortions of the optical imaging lens 10 of the second embodiment, respectively. In FIG. 10, the abscissa represents the Y-field offset angle, that is, an angle between the field of view of the optical imaging lens 10 and the optical axis, and the ordinate represents the OTF coefficient. The curve at lower frequency can reflect the contrast characteristics of the optical imaging lens 10, and the curve at higher frequency can reflect the resolution characteristics of the optical imaging lens 10. FIG. 11 represents the meridian field curvature and the sagittal field curvature, in which the maximum value of each of the sagittal field curve and meridional field curve is less than 0.2 mm, indicating good compensation. The distortion curve in FIG. 12 shows the distortion values corresponding to different field angles, in which the maximum distortion is less than 10%, indicating that the distortion has been corrected. Therefore, the optical imaging lens 10 can have a large aperture, a wide field of view, and a small size.

### Fourth Embodiment

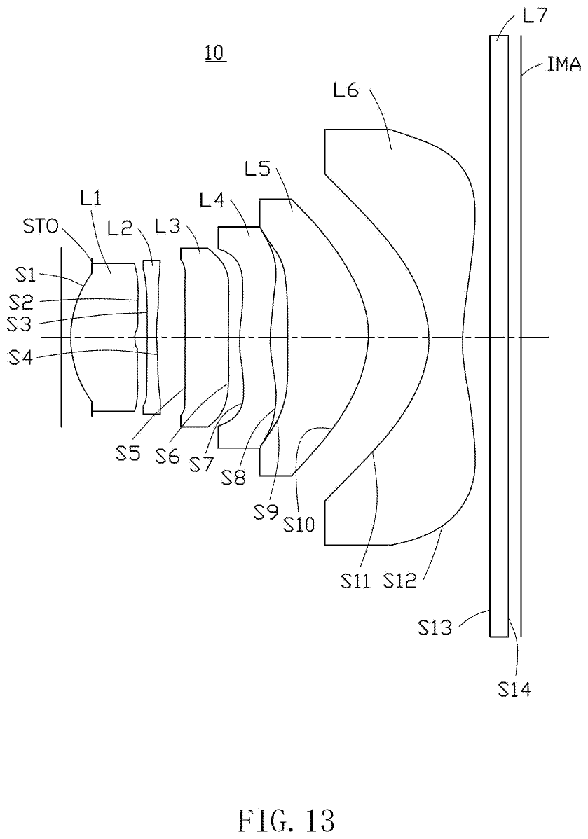

Referring to FIG. 13, the optical imaging lens 10 includes, from the object side to the image side, an aperture STO, a first lens L1 with a refractive power, a second lens L2 with a negative refractive power, a third lens L3 with a negative refractive power, a fourth lens L4 with a refractive power, a fifth lens L5 with a positive refractive power, a sixth lens 16 with a negative refractive power, and an infrared filter L7. The first lens L1, the second lens L2, the third lens L3, the fourth lens L4, the fifth lens L5 and the sixth lens L6 are made of glass, and the infrared filter L7 is also made of glass.

The object surface S1 of the first lens L1 is convex near the optical axis, the object surface S9 of the fifth lens L5 is convex near the optical axis, the image surface S10 of the fifth lens L5 is convex near the optical axis, and the object surface S11 of the sixth lens L6 is concave near the optical axis.

When the optical imaging lens 10 is used, rays from the object side enter the optical imaging lens 10, successively pass through the stop STO, the first lens L1, the second lens L2, the third lens L3, the fourth lens L4, the fifth lens L5, the sixth lens L6, and the infrared filter L7, and finally converge on the image surface IMA.

Table 10 shows basic parameters of the optical imaging lens 10.

TABLE 10

| | |
|---|---|
| Imgh (unit: mm) | 3.35 |
| TTL (unit: mm) | 5.2797 |
| FOV (unit: °) | 84 |
| TL1 (unit: mm) | 4.4267 |
| TL2 (unit: mm) | 4.1873 |
| TL3 (unit: mm) | 3.3579 |
| TL4 (unit: mm) | 2.8859 |
| TL5 (unit: mm) | 1.7622 |
| TL6 (unit: mm) | 0.6721 |
| V1 | 55.951198 |
| V2 | 20.372904 |
| V3 | 55.951198 |
| V4 | 20.372904 |
| V5 | 55.951198 |
| V6 | 55.951198 |
| EPD (unit: mm) | 1.916 |
| f (unit: mm) | 4.011 |

Table 11 shows characteristics of the optical imaging lens 10. The reference wavelength of focal length, refractive index, and Abbe number is 558 nm, and the units of radius of curvature, thickness, and semi-diameter are in millimeters (mm).

TABLE 11
Fourth embodiment

| | | | radius of | | | refractive | Abbe | semi- |
|---|---|---|---|---|---|---|---|---|
| Surface | lens | Type of surface | curvature | thickness | material | index | number | diameter |
| object | | standard surface | infinite | infinite | | | | infinite |
| surface | | standard surface | infinite | | | | | |
| STO | | standard surface | infinite | −0.24 | | | | 0.958 |
| S1 | first lens | even aspheric | 1.976 | 0.743 | glass | 1.54 | 56 | 0.96 |
| | | surface | | | | | | |
| S2 | | even aspheric | 11.194 | 0.126 | | | | 1.049 |
| | | surface | | | | | | |
| S3 | second | even aspheric | −63.421 | 0.114 | glass | 1.66 | 20.4 | 1.067 |
| | lens | surface | | | | | | |
| S4 | | even aspheric | 14.380 | 0.317 | | | | 1.099 |
| | | surface | | | | | | |
| S5 | third lens | even aspheric | 23.248 | 0.512 | glass | 1.54 | 56 | 1.163 |
| | | surface | | | | | | |
| S6 | | even aspheric | −58.978 | 0.124 | | | | 1.278 |
| | | surface | | | | | | |
| S7 | fourth | even aspheric | 4.416 | 0.348 | glass | 1.66 | 20.4 | 1.273 |
| | lens | surface | | | | | | |
| S8 | | even aspheric | 3.144 | 0.186 | | | | 1.570 |
| | | surface | | | | | | |
| S9 | fifth lens | even aspheric | 18.827 | 0.937 | glass | 1.54 | 56 | 1.543 |
| | | surface | | | | | | |
| S10 | | even aspheric | −1.893 | 0.700 | | | | 1.967 |
| | | surface | | | | | | |
| S11 | sixth lens | even aspheric | −2.022 | 0.390 | glass | 1.54 | 56 | 2.381 |
| | | surface | | | | | | |
| S12 | | even aspheric | 3.618 | 0.312 | | | | 2.977 |
| | | surface | | | | | | |
| S13 | infrared | standard surface | infinite | 0.210 | glass | 1.52 | 64.2 | 4.3 |
| S14 | filter | standard surface | infinite | 0.150 | | | | 4.3 |
| IMA | | standard surface | infinite | 0.000 | | | | 4.3 |

Table 12 shows the aspherical coefficients of the optical imaging lens 10.

TABLE 12
Fourth embodiment

| Surface | K | A2 | A4 | A6 | A8 | A10 | A12 | A14 |
|---|---|---|---|---|---|---|---|---|
| S1 | 0.166 | 0.000E+00 | −8.398E−003 | −2.986E−003 | −4.094E−003 | −1.280E−003 | −3.414E−004 | −3.280E−004 |
| S2 | −62.460 | 0.000E+00 | −0.030 | −0.020 | −7.392E−003 | −1.587E−003 | 7.690E−004 | 1.132E−003 |
| S3 | −5655.571 | 0.000E+00 | −0.028 | −5.887E−003 | −4.097E−003 | −8.655E−004 | 9.607E−004 | 1.520E−003 |
| S4 | 107.506 | 0.000E+00 | 1.385E−003 | −1.750E−003 | 2.758E−004 | −2.197E−003 | −1.088E−003 | −3.537E−004 |
| S5 | −1035.908 | 0.000E+00 | 0.011 | −0.027 | −3.289E−003 | 2.341E−003 | 3.716E−004 | −1.079E−003 |
| S6 | 1409.981 | 0.000E+00 | −0.021 | −0.021 | −7.188E−003 | −3.147E−003 | −7.558E−004 | −9.500E−005 |
| S7 | −46.867 | 0.000E+00 | −0.050 | −0.014 | −8.225E−003 | −2.732E−003 | −7.769E−004 | −7.005E−004 |
| S8 | −24.002 | 0.000E+00 | −0.043 | −9.947E−003 | −4.090E−004 | −8.067E−005 | 1.176E−006 | 5.349E−005 |
| S9 | −2198.728 | 0.000E+00 | −0.045 | −0.011 | −4.387E−003 | 5.006E−004 | 1.373E−003 | 4.905E−004 |
| S10 | −3.372 | 0.000E+00 | −0.016 | −3.018E−003 | 7.913E−004 | 2.936E−004 | 4.607E−005 | −3.822E−006 |
| S11 | −1.019 | 0.000E+00 | −3.218E−003 | 1.220E−003 | 1.546E−004 | −5.576E−006 | −3.347E−006 | −4.289E−007 |
| S12 | −13.715 | 0.000E+00 | −0.030 | 7.958E−003 | −1.230E−003 | 4.277E−005 | 5.393E−006 | −4.416E−007 |

It should be noted that each surface of the lens of the optical imaging lens 10 may be aspherical. Such aspherical equation of the aspherical surface satisfies the above formula (8).

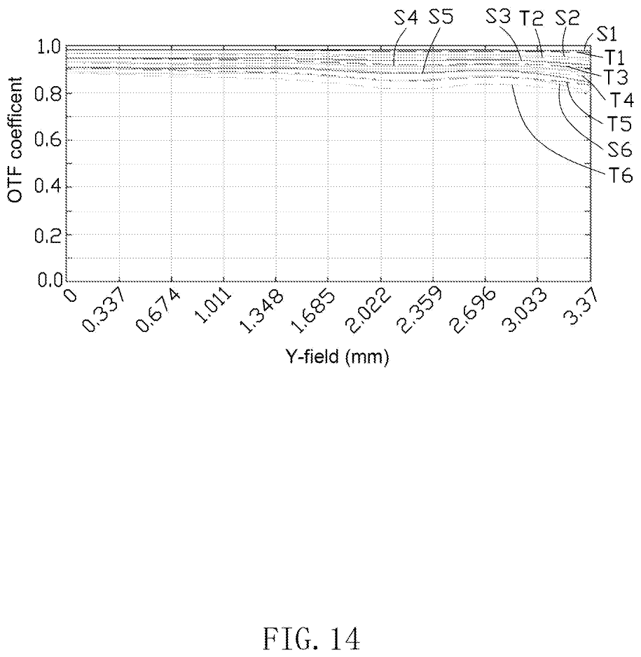

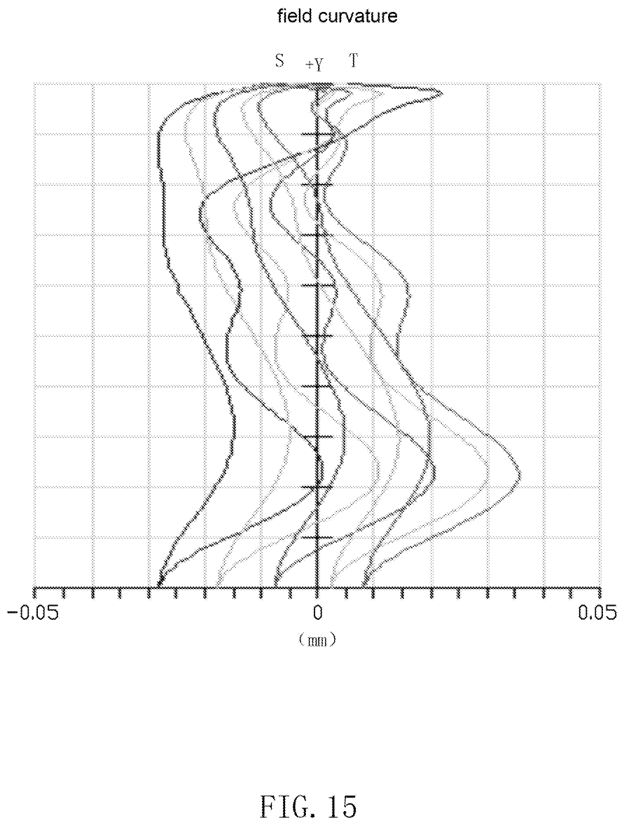

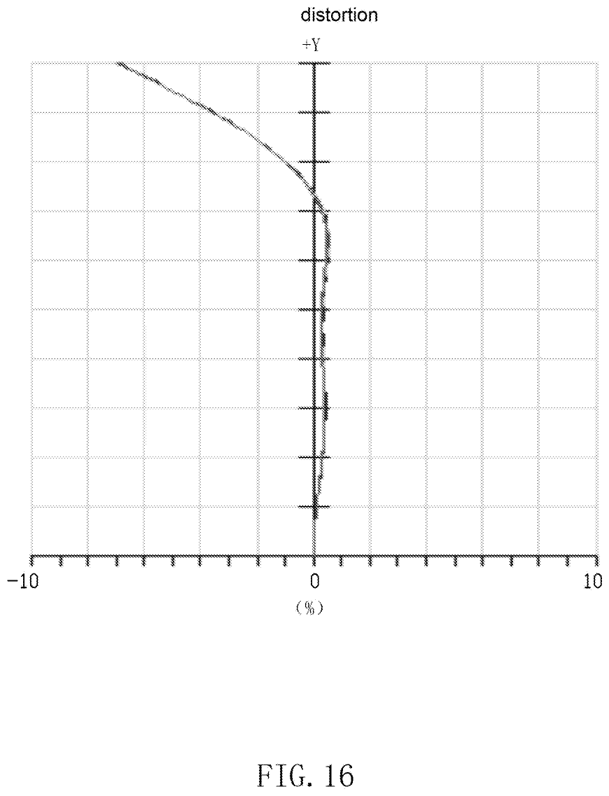

FIGS. 14 to 16 show the MTF curves, the field curvatures, and the distortions of the optical imaging lens 10 of the fourth embodiment, respectively. In FIG. 14, the abscissa represents Y-field offset angle, that is, an angle between the field of view of the optical imaging lens 10 and the optical axis, and the ordinate represents the OTF coefficient. The curve at a lower frequency can reflect the contrast characteristics of the optical imaging lens 10 and the curve at a higher frequency can reflect the resolution characteristics of the optical imaging lens 10. FIG. 15 represents the meridian field curvature and the sagittal field curvature, in which the maximum value of each of the sagittal field curve and the meridional field curve is less than 0.05 mm, indicating good compensation. The distortion curve in FIG. 16 shows the distortion values corresponding to different field angles, in which the maximum distortion is less than 10%, indicating that the distortion has been corrected. Therefore, the optical imaging lens 10 can have a large aperture, a wide field of view, and a small size.

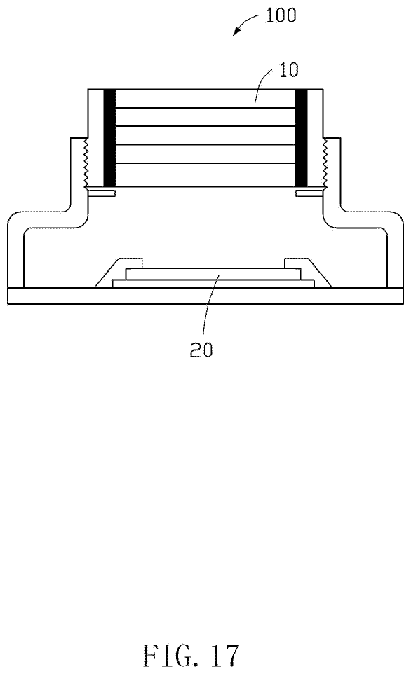

Referring to FIG. 17, an embodiment of an imaging module 100 is further provided, which includes the optical imaging lens 10 and an optical sensor 20. The optical sensor 20 is arranged on the image side of the optical imaging lens 10. The optical sensor 20 can be a CMOS (complementary metal oxide semiconductor) sensor or a charge coupled device (CCD).

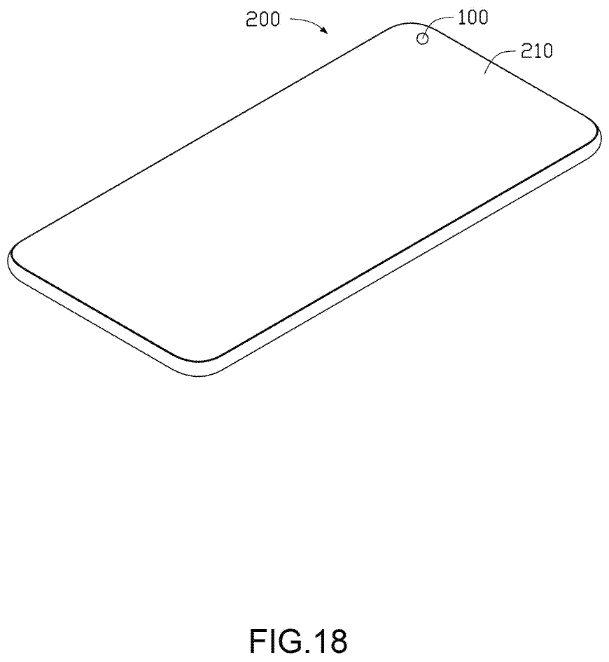

Referring to FIG. 18, an embodiment of an electronic device 200 is further provided, which includes the imaging module 100 and a housing 210. The imaging module 100 is mounted on the housing 210. The electronic device 200 can be a tachograph, a smart phone, a tablet computer, a notebook computer, an e-book reader, a portable multimedia player (PMP), a portable telephone, a video telephone, a digital camera, a mobile medical device, a wearable device, etc.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An optical imaging lens, from an object side to an image side, composed of:
a first lens;
a second lens having a positive refractive power;
a third lens having a negative refractive power;
a fourth lens;
a fifth lens having a positive refractive power, wherein an image surface of the fifth lens is convex near an optical axis of the optical imaging lens; and
a sixth lens having a negative refractive power, wherein at least one of an object surface of the fifth lens, the image surface of the fifth lens, an object surface of the sixth lens, and an image surface of the sixth lens is aspheric, and has at least one critical point near the optical axis;
wherein the optical imaging lens satisfies following formula:
50<V6<60, 2<TTL/EPD<3;
wherein, V6 is a dispersion coefficient of the sixth lens, TTL is a distance from an object surface of the first lens to an image plane of the optical imaging lens along the optical axis, and EPD is an entrance pupil diameter of the optical imaging lens.

2. The optical imaging lens of claim 1, wherein the object surface of the first lens is convex near the optical axis, the image surface of the fifth lens is convex near the optical axis, and the object surface of the sixth lens is concave near the optical axis.

3. The optical imaging lens of claim 1, further satisfying following formula:
0.84<Imgh/f<1.19.
wherein, Imgh is an image height corresponding to half of a maximum field of view of the optical imaging lens, and f is an effective focal length of the optical imaging lens.

4. The optical imaging lens of claim 1, further satisfying following formula:
1.41<(V2+V3+V5)/(V1+V4)<1.73.
wherein V1 is a dispersion coefficient of the first lens, V2 is a dispersion coefficient of the second lens, V3 is a dispersion coefficient of the third lens, V4 is a dispersion coefficient of the fourth lens, and V5 is a dispersion coefficient of the fifth lens.

5. The optical imaging lens of claim 1, further satisfying following formula:
1.07<TL1/f<1.68.
wherein TL1 is a distance from the object surface of the first lens to the image plane along the optical axis, and f is an effective focal length of the optical imaging lens.

6. The optical imaging lens of claim 1, further satisfying following formula:
35.51° /mm<FOV/TL6<124.98° /mm.
wherein, FOV is a maximum field of view of the optical imaging lens, and TL6 is a distance from the object surface of the fifth lens to the image plane along the optical axis.

7. The optical imaging lens of claim 1, further satisfying following formula:
9.82° /mm<FOV/f<20.94° /mm.
wherein, FOV is a maximum field of view of the optical imaging lens, and f is an effective focal length of the optical imaging lens.

8. The optical imaging lens of claim 1, further satisfying following formula:
1.41<TTL/Imgh<1.58.
wherein, TTL is a distance from the object surface of the first lens to the image plane along the optical axis, and Imgh is an image height corresponding to half of a maximum angle of the optical imaging lens.

9. An imaging module comprising:
an optical imaging lens, from an object side to an image side, composed of:
a first lens;
a second lens having a positive refractive power;
a third lens having a negative refractive power;
a fourth lens;
a fifth lens having a positive refractive power, wherein an image surface of the fifth lens is convex near an optical axis of the optical imaging lens; and
a sixth lens having a negative refractive power, wherein at least one of an object surface of the fifth lens, the image surface of the fifth lens, an object surface of the sixth lens, and an image surface of the sixth lens is aspheric, and has at least one critical point near the optical axis; and
an optical sensor arranged on the image side of the optical imaging lens;
wherein the optical imaging lens satisfies following formula:
50<V6<60, 2<TTL/EPD<3;
wherein, V6 is a dispersion coefficient of the sixth lens, TTL is a distance from an object surface of the first lens to an image plane of the optical imaging lens along the optical axis, and EPD is an entrance pupil diameter of the optical imaging lens; and

[symbol]

10. The imaging module of claim 9, wherein the object surface of the first lens is convex near the optical axis, the image surface of the fifth lens is convex near the optical axis, and the object surface of the sixth lens is concave near the optical axis.

11. The imaging module of claim 9, wherein the optical imaging lens further satisfies following formula:
0.84<Imgh/f<1.19.
wherein, Imgh is an image height corresponding to half of a maximum field of view of the optical imaging lens, and f is an effective focal length of the optical imaging lens.

12. The imaging module of claim 9, wherein the optical imaging lens further satisfies following formula:
1.41<(V2+V3+V5)/(V1+V4)<1.73.
wherein V1 is a dispersion coefficient of the first lens, V2 is a dispersion coefficient of the second lens, V3 is a dispersion coefficient of the third lens, V4 is a dispersion coefficient of the fourth lens, and V5 is a dispersion coefficient of the fifth lens.

13. The imaging module of claim 9, wherein the optical imaging, lens further satisfies following formula:
1.07<TL1/f<1.68.
wherein TL1 is a distance from the object surface of the first lens to the image plane along the optical axis, and f is an effective focal length of the optical imaging lens.

14. The imaging module of claim 9, wherein the optical imaging lens further satisfies following formula:
35.51° /mm<FOV/TL6<124.98° /mm.
wherein, FOV is a maximum field of view of the optical imaging lens, and TL6 is a distance from the object surface of the fifth lens to the image plane along the optical axis.

15. The imaging module of claim 9, wherein the optical imaging lens further satisfies following formula:
9.82° /mm<FOV/f<20.94° /mm.
wherein, FOV is a maximum field of view of the optical imaging lens, and f is an effective focal length of the optical imaging lens.

16. The imaging module of claim 9, wherein the optical imaging lens further satisfies following formula:
1.41<TTL/Imgh<1.58.
Wherein, TTL is a distance from the object surface of the first lens to the image plane along the optical axis, and Imgh is an image height corresponding to half of a maximum angle of the optical imaging lens.

17. An electronic device comprising:
a housing; and
an imaging module mounted on the housing, the imaging module comprising:
an optical imaging lens, from an object side to an image side, composed of
a first lens;
a second lens having a positive refractive power;
a third lens having a negative refractive power;
a fourth lens;
a fifth lens having a positive refractive power, wherein an image surface of the fifth lens is convex near an optical axis of the optical imaging lens; and
a sixth lens having a negative refractive power, wherein at least one of an object surface of the fifth lens, the image surface of the fifth lens, an object surface of the sixth lens, and an image surface of the sixth lens is aspheric, and has at least one critical point near the optical axis; and
an optical sensor arranged on the image side of the optical imaging lens;
wherein the optical imaging lens satisfies following formula:
50<V6<60, 2<TTL/EPD<3;
wherein, V6 is a dispersion coefficient of the sixth lens, TTL is a distance from an object surface of the first lens to an image plane of the optical imaging lens along the optical axis, and EPD is an entrance pupil diameter of the optical imaging lens; and

[symbol]

18. The electronic device of claim 17, wherein the object surface of the first lens is convex near the optical axis, the image surface of the fifth lens is convex near the optical axis, and the object surface of the sixth lens is concave near the optical axis.

19. The electronic device of claim 17, wherein the optical imaging lens further satisfies following formula:
0.84<Imgh/f<1.19.
wherein, Imgh is an image height corresponding to half of a maximum field of view of the optical imaging lens, and f is an effective focal length of the optical imaging lens.

20. The electronic device of claim 17, wherein the optical imaging lens further satisfies following formula:
1.41<(V2+V3+V5)/(V1+V4)<1.73.
wherein V1 is a dispersion coefficient of the first lens, V2 is a dispersion coefficient of the second lens, V3 is a dispersion coefficient of the third lens, V4 is a dispersion coefficient of the fourth lens, and V5 is a dispersion coefficient of the fifth lens.
